(19) United States
(12) Patent Application Publication
(10) Pub. No.: US 2025/0239802 A1
(43) Pub. Date: Jul. 24, 2025

(54) ELECTRICAL SHIELD FOR AN ELECTRICAL CONNECTOR

(71) Applicants: TE Connectivity Solutions GmbH, Schaffhausen (CH); TE CONNECTIVITY BRASIL INDUSTRIA DE ELECTRONICOS LTDA, Braganca Paulista (BR)

(72) Inventors: Dinesh Hemnani, Winston Salem, NC (US); Kevin John Peterson, Winston Salem, NC (US); Amadeu Luiz Fazani Cavallieri, Campinas (BR)

(21) Appl. No.: 18/416,014

(22) Filed: Jan. 18, 2024

(51) Int. Cl. H01R 13/502; H01R 13/52; H01R 13/639; H01R 103/00

(52) U.S. Cl. CPC H01R 13/502; H01R 13/5202; H01R 13/639; H01R 2103/00

(57) ABSTRACT

A header connector includes a header housing that includes a base having a terminal cavity. The header housing includes a mounting flange mounted to a first surface of a panel. The base is received in an opening in the panel. The header housing includes a shroud forming a chamber configured to receive a plug connector. The base includes a housing latching feature. The header connector includes a panel seal coupled to the header housing located between the mounting flange and the panel. The header connector includes a mounting clip having a plate mounted to a second surface of the panel. The mounting clip includes a clip latching feature interacting with the housing latching feature to secure the header housing to the panel. The mounting clip is secured to the base of the header housing such that the panel is captured between the plate of the mounting clip and the mounting flange of the header housing.

### BACKGROUND OF THE INVENTION

The subject matter herein relates generally to electrical connectors.

Electrical connectors are used to electrically connect various components. For example, some known electrical connectors are power connectors used to supply power to the various components. The power connectors may be used in high power applications, such as in electric or hybrid electric vehicles, between the battery and other components, such as the electric motor, the inverter, the charger, and the like. One of the power connectors is typically mounted to a structure, such as a panel, such as a panel of the battery module. For example, the power connectors may be bolted to the panel. However, the bolting process requires additional components, such as threaded bolts, which are individually tightened. The bolting process adds cost, complexity and time to the assembly process.

A need remains for electrical connectors that may be assembled in a cost-effective and reliable manner.

### BRIEF DESCRIPTION OF THE INVENTION

In an embodiment herein, a header connector is provided and includes a header housing that includes a base having a terminal cavity. The header housing includes a mounting flange extending from the base to define a mounting end configured to be mounted to a first surface of a panel. The base is received in an opening in the panel. The header housing includes a shroud forming a chamber configured to receive a plug housing of a plug connector. The base includes a housing latching feature. The header connector includes a header terminal received in the terminal cavity and held by the base. The header terminal has a mating end configured to mate with a plug terminal of the plug connector. The header connector includes a panel seal coupled to the header housing. The panel seal configured to be located between the mounting flange and the panel. The header connector includes a mounting clip that has a plate configured to be mounted to a second surface of the panel. The mounting clip includes a clip latching feature interacting with the housing latching feature to secure the header housing to the panel. The mounting clip is secured to the base of the header housing such that the panel is captured between the plate of the mounting clip and the mounting flange of the header housing.

In another embodiment, a header connector is provided and includes a header housing that includes a base having a terminal cavity. The header housing includes a mounting flange extending from the base to define a mounting end configured to be mounted to a first surface of a panel. The base is received in an opening in the panel. The header housing includes a shroud forming a chamber configured to receive a plug housing of a plug connector. The base includes a housing pre-stage latching feature. The base includes a housing latching feature. The header connector includes a header terminal received in the terminal cavity and held by the base. The header terminal has a mating end configured to mate with a plug terminal of the plug connector. The header connector includes a panel seal coupled to the header housing. The panel seal configured to be located between the mounting flange and the panel. The header connector includes a mounting clip that has a plate configured to be mounted to a second surface of the panel. The mounting clip includes a clip pre-stage latching feature interacting with the housing pre-stage latching feature to secure the mounting clip to the header housing at a pre-stage position. The mounting clip includes a clip latching feature interacting with the housing latching feature to secure the mounting clip to the header housing at a final mounted position. The panel is captured between the plate of the mounting clip and the mounting flange of the header housing when the mounting clip is latchably coupled to the header housing. A distance between the plate and the mounting flange is decreased from the pre-stage position and the final mounted position.

In a further embodiment, a power connector system is provided and includes a header connector that includes a header housing having a base that has a terminal cavity. The header housing includes a mounting flange extending from the base defining a mounting end configured to be mounted to a first surface of a panel. The base is received in an opening in the panel. The header housing includes a shroud forming a chamber configured to receive a plug housing of a plug connector. The base includes a housing latching feature. The header connector includes a header terminal received in the terminal cavity and held by the base. The header connector includes a panel seal coupled to the header housing and configured to be located between the mounting flange and the panel, and the header connector includes a mounting clip has a plate configured to be mounted to a second surface of the panel. The mounting clip includes a clip latching feature interacting with the housing latching feature to secure the header housing to the panel. The mounting clip is secured to the base of the header housing such that the panel is captured between the plate of the mounting clip and the mounting flange of the header housing. The power connector system includes a plug connector coupled to the header connector. The plug connector includes a plug housing holding plug terminal. The plug housing received in the chamber to mate the plug terminal to the header terminal.

### BRIEF DESCRIPTION OF THE DRAWINGS

FIG. 1 is a top perspective view of a power connector system in accordance with an exemplary embodiment.

FIG. 2 is a bottom perspective view of a power connector system in accordance with an exemplary embodiment.

FIG. 3 is an exploded view of the power connector system in accordance with an exemplary embodiment.

FIG. 4 is a bottom perspective view of the plug connector in accordance with an exemplary embodiment.

FIG. 5 is a cross-sectional view of the plug connector in accordance with an exemplary embodiment.

FIG. 6 is a top perspective view of the header connector in accordance with an exemplary embodiment.

FIG. 7 is a bottom perspective view of the header connector in accordance with an exemplary embodiment.

FIG. 8 is a top perspective view of the mounting clip in accordance with an exemplary embodiment.

FIG. 9 is a bottom perspective view of the mounting clip in accordance with an exemplary embodiment.

FIG. 10 is an exploded, perspective view of the header connector poised for mounting to the panel in accordance with an exemplary embodiment.

FIG. 11 is a side view of the header connector mounted to the panel in accordance with an exemplary embodiment.

FIG. 12 is an exploded, perspective view showing the mounting clip poised for mounting to the header housing and the panel 50 in accordance with an exemplary embodiment.

FIG. 13 is a side view of the mounting clip coupled to the header connector and the panel in accordance with an exemplary embodiment.

FIG. 14 is a top perspective view of the power connector system showing the plug connector partially coupled to the header connector in accordance with an exemplary embodiment.

FIG. 15 is a side view of the power connector system showing the plug connector partially coupled to the header connector in accordance with an exemplary embodiment.

FIG. 16 is a cross-sectional view of the power connector system showing the plug connector partially coupled to the header connector in accordance with an exemplary embodiment.

FIG. 17 is a side view of the power connector system showing the plug connector fully coupled to the header connector in accordance with an exemplary embodiment.

FIG. 18 is a cross-sectional view of the power connector system showing the plug connector fully coupled to the header connector in accordance with an exemplary embodiment.

FIG. 19 is a bottom perspective view of the power connector system showing the plug connector fully coupled to the header connector in accordance with an exemplary embodiment.

### DETAILED DESCRIPTION OF THE INVENTION

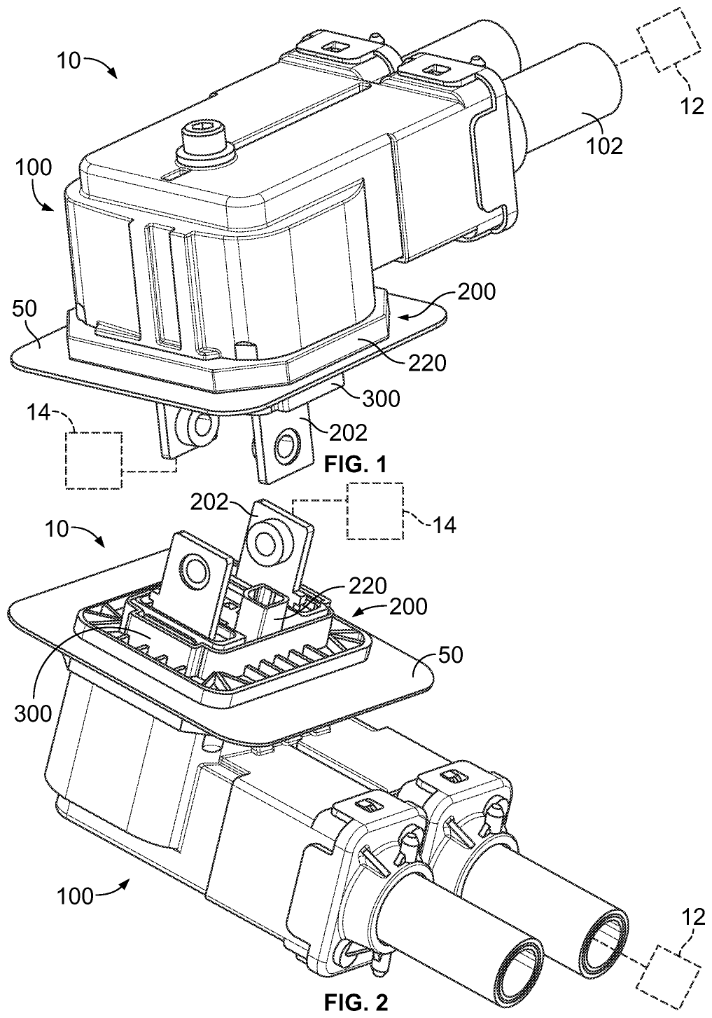

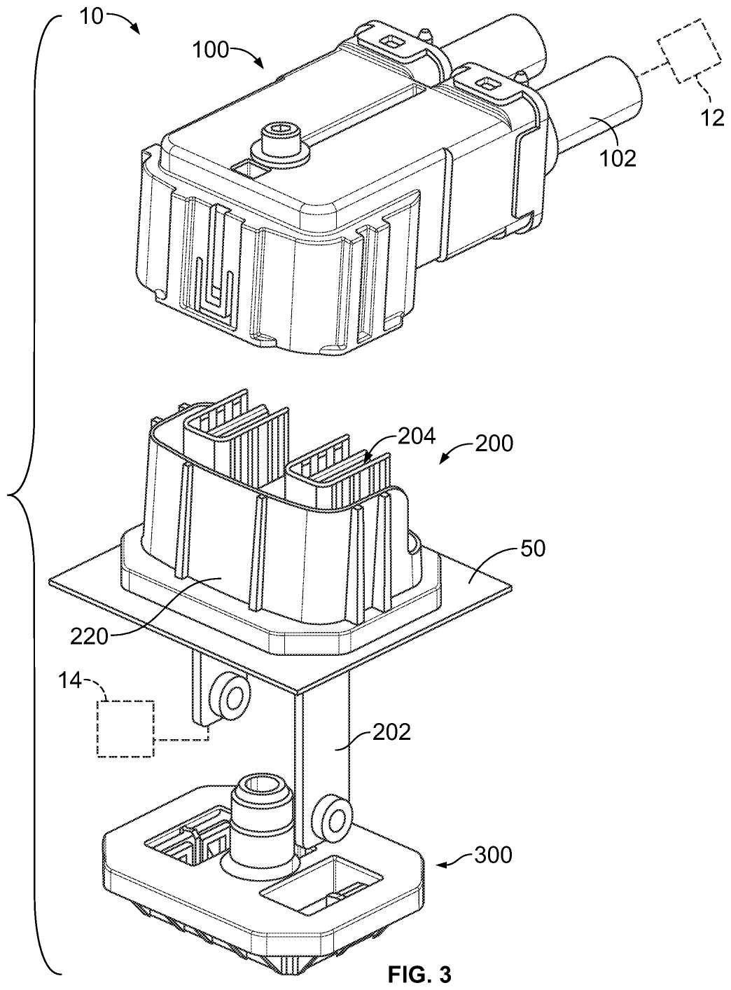

FIG. 1 is a top perspective view of a power connector system 10 in accordance with an exemplary embodiment. FIG. 2 is a bottom perspective view of a power connector system 10 in accordance with an exemplary embodiment. FIG. 3 is an exploded view of the power connector system 10 in accordance with an exemplary embodiment.

The power connector system 10 includes a plug connector 100 configured to be mated with a header connector 200. The header connector 200 is mounted to a structure, such as a panel 50 of a component. For example, the panel 50 may be a wall or shell or housing of an electrical component, such as a battery module. The header connector 200 is mounted to the structure at an opening 52 (shown in FIG. 10) such that that header connector 200 passes through the panel 50.

In an exemplary embodiment, the panel 50 is conductive. For example, the panel 50 may be manufactured from a metal material, such as steel. In an exemplary embodiment, the panel 50 is a coated structure wherein an outer layer of the panel 50 is a coated layer. The coated surface protects the panel 50, such as from corrosion, by covering the conductive layer. Optionally, the header connector 200 may be mounted horizontally; however, other orientations are possible in alternative embodiments. Fasteners may be used to mount the header connector 200 to the panel 50.

In an exemplary embodiment, the power connector system 10 is a high power connector system that is used to transfer power between various components as part of a high power circuit. In a particular application, the power connector system 10 is a battery system, such as a battery system of a vehicle, such as an electric vehicle or hybrid electric vehicle; however the power connector system 10 is not intended to be limited to such battery systems.

The plug connector 100 is configured to be electrically connected to a component 12, such as through one or more power cables 102. For example, the plug connector 100 may be electrically connected to a battery, a charger, an inverter, an electric motor or another type of component. The header connector 200 is configured to be electrically connected to a component 14, such as through one or more power bus 202; however the header connector 200 may be electrically connected to the component 14 by other means, such as a terminal, power wire or other connector. For example, the header connector 200 may be electrically connected to a battery pack, such as through a battery distribution unit, a manual service disconnect, a charger, an inverter, an electric motor, or another type of component. The battery distribution unit may manage the power capacity and functionality of the power connector system 10, such as by measuring current and regulating power distribution of the battery pack.

In various embodiments, the power connector system 10 is a right angle connector system where the connectors 100, 200 are mated in a direction perpendicular to the power cables 102. Optionally, the plug connector 100 may be removably coupled to the header connector 200 to disconnect the high power circuit of one or more of the components, such as the battery pack, the electric motor, the inverter, or other components of the vehicle, such as for maintenance, repair or for another reason. When mated, one or more header terminals 204 of the header connector 200 are mated with corresponding plug terminals (not shown) of the plug connector 100, such as at mating interfaces thereof. The header terminals 204 are electrically connected to the power bus 202 to transfer power from the power cables 102 to the power bus 202 through the header terminals 204 and the plug terminals.

The header connector 200 includes a header housing 220 holding the header terminals 204. The header connector 200 includes a mounting clip 300 for mounting the header housing 220 to the panel 50. In an exemplary embodiment, the mounting clip 300 is secured directly to the header housing 220. For example, the mounting clip 300 is secured to the header housing 220 by latching or clipping to the header housing 220. The mounting clip 300 may be quickly coupled to the header housing 220 during installation. For example, the mounting clip 300 is secured to the header housing 220 without the use of tools. In an exemplary embodiment, the header housing 220 is secured to the panel 50 using the mounting clip 300. A boltless connection is made using the mounting clip 300 rather than using threaded bolts to secure the header housing 220 to the panel 50. As such, assembly of the header housing 220 to the panel 50 may be made quickly and reliably without the use of bolts and tools.

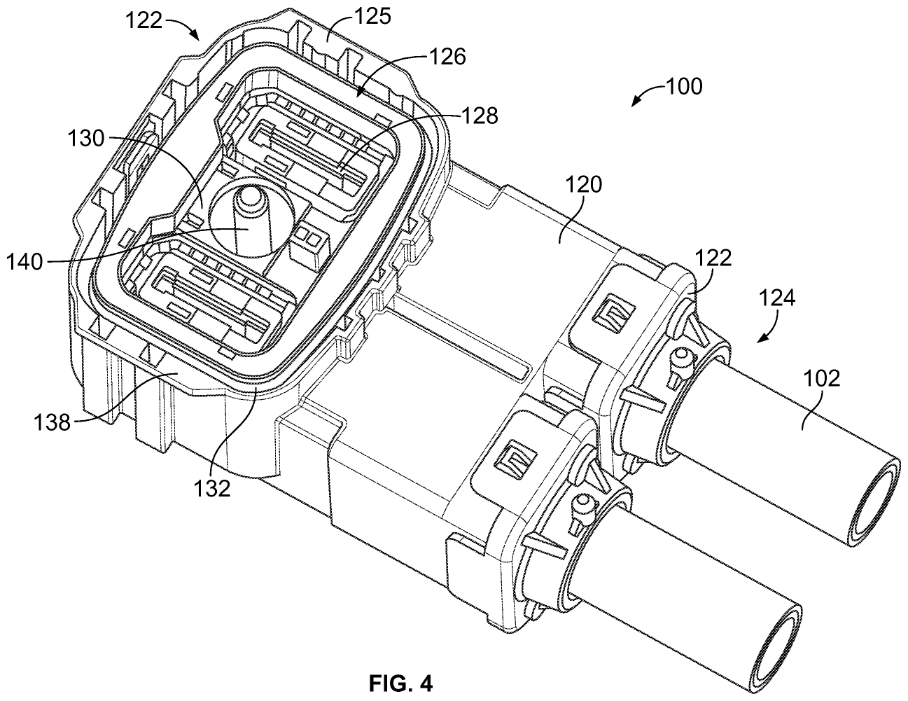

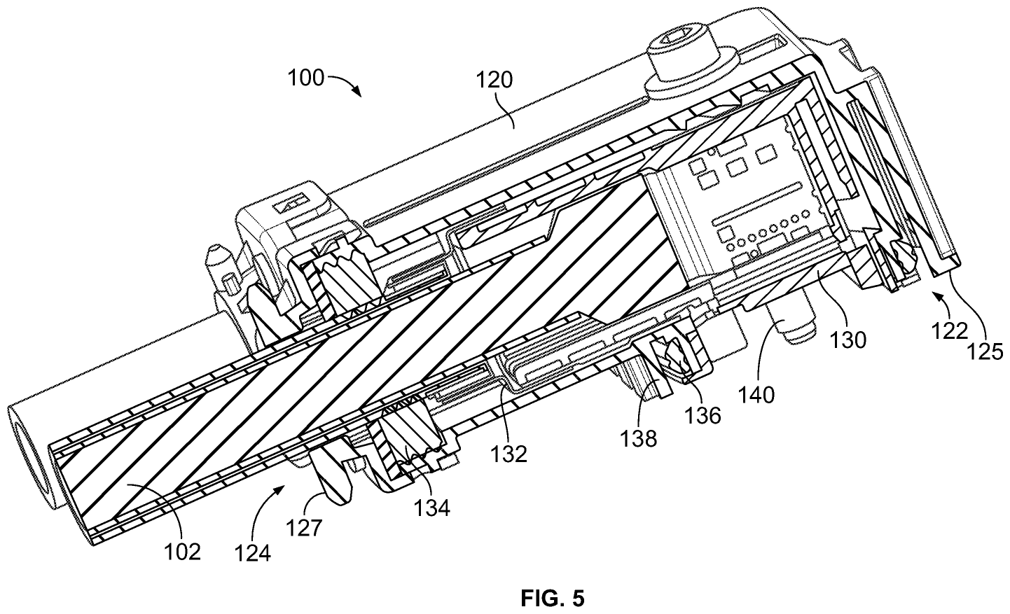

FIG. 4 is a bottom perspective view of the plug connector 100 in accordance with an exemplary embodiment. FIG. 5 is a cross-sectional view of the plug connector 100 in accordance with an exemplary embodiment. The plug connector 100 is provided at the ends of the power cables 102. The plug connector 100 is used to electrically connect the power cables 102 to the header connector 200. The plug connector 100 forms a separable mating interface with the header connector 200.

The plug connector 100 includes a plug housing 120 having a mating end 122 and a cable end 124. In the illustrated embodiment, the mating end 122 is provided at a bottom 125 of the plug housing 120. Other locations are possible in alternative embodiments. In the illustrated embodiment, the cable end 124 is provided at a rear 127 of the plug housing 120. Other locations are possible in alternative embodiments. In an exemplary embodiment, the plug connector 100 is a right angle connector. For example, the mating end 122 is oriented perpendicular to the cable end 124. In alternative embodiments, the plug connector 100 may be a straight pass-through connector, such as having the mating end 122 opposite the cable end 124 (for example, at the top and the bottom or at the front and the rear).

The plug connector 100 includes a cavity 126 that receives the power cables 102 and plug terminals 128 terminated to ends of the power cables 102. For example, the plug terminals 128 may be welded, soldered, crimped, or otherwise terminated to the ends of the power cables 102. In the illustrated embodiment, the plug connector 100 receives a pair of the power cables 102 and a pair of the plug terminals 128. The plug connector 100 may hold greater or fewer plug terminals 128 and power cables 102 in alternative embodiments. In an exemplary embodiment, the plug connector 100 includes a terminal holder 130 that holds the plug terminals 128. The terminal holder 130 is located in the cavity 126. In an exemplary embodiment, the electrical shield 132 surrounds the terminal holder 130 to provide shielding for the plug terminals 128. The electrical shield 132 may be electrically connected to cable shields of the power cables 102.

In an exemplary embodiment, the plug connector 100 includes cable seals 134 sealed between the plug housing 120 and the power cables 102. The cable seals 134 may be located at the cable end 124. In an exemplary embodiment, the plug connector 100 includes an interface seal 136 at the mating end 122. The interface seal 136 is configured to seal at the interface with the header connector 200. In an exemplary embodiment, the plug housing 120 includes an outer wall 138 surrounding the interface seal 136 at the mating end 122. The outer wall 138 may be coupled to the header connector 200. In an exemplary embodiment, a portion of the header connector 200 may be plugged into the cavity 126 interior of the outer wall 138. For example, the outer wall 138 may surround a portion of the header connector 200 thereto in an exemplary embodiment, a plug portion of the plug connector 100 is configured to be plugged into the header connector 200 when mated to the header connector 200. For example, portions of the 30 and the plug terminals 128 may be plugged into the header connector 200.

In an exemplary embodiment, the plug connector 100 includes a threaded bolt 140 that passes through the plug connector 100. The threaded bolt 140 is used to secure the plug connector 100 to the header connector 200. In an exemplary embodiment, the threaded bolt 140 may be threadably coupled to the mounting clip 300 (FIG. 3). The threaded bolt 140 may be tightened to force mating of the plug connector 100 with the header connector 200, such as to force mating of the plug terminals 128 with the header terminals 204.

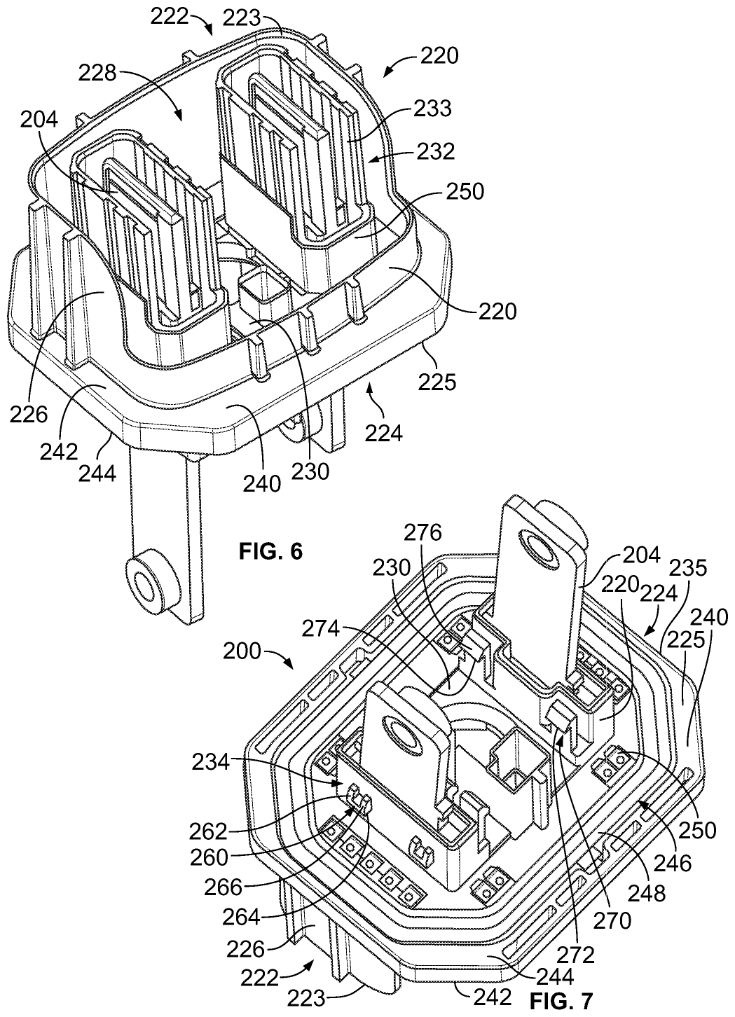

FIG. 6 is a top perspective view of the header connector 200 in accordance with an exemplary embodiment. FIG. 7 is a bottom perspective view of the header connector 200 in accordance with an exemplary embodiment.

The header connector 200 includes a header housing 220 having a mating end 222 at a top 223 of the header housing 220 and a mounting end 224 at a bottom 225 of the header housing 220. The header housing 220 includes shroud walls 226 extending to the top 223. The shroud walls 226 form a chamber 228 configured to receive the plug connector 100. The header housing 220 includes a base 230 at the bottom 225. The shroud walls 226 extend upward from the base 230. The base 230 holds the header terminals 204. In an exemplary embodiment, the base 230 includes an upper portion 232 and a lower portion 234. The upper portion 232 is configured to be located above the panel 50. The lower portion 234 is configured to be located below the panel 50. In the illustrated embodiment, the upper portion 232 includes one or more protrusions or towers 233 holding upper portions of the header terminals 204. In the illustrated embodiment, the lower portion 234 includes one or more protrusions or towers 235 holding lower portions of the header terminals 204.

The base 230 holds the header terminals 204. In the illustrated embodiment, the header terminals 204 include tabs or blades at the mating end configured to be mated with the plug terminals 128. Other types of terminals may be used in alternative embodiments, such as socket contacts, pin contacts, spring beam contacts, or other types of contacts. Optionally, the header terminals 204 may be fork terminals having sockets defined by spring beams on both sides of the sockets to mate with both sides of the plug terminal.

In an exemplary embodiment, the header housing 220 includes a mounting flange 240 at the mounting end 224. The mounting flange 240 extends from the base 230. The mounting flange 240 is used for mounting the header housing 220 to the panel 50. The mounting flange 240 includes an upper surface 242 and a lower surface 244. The lower surface 244 is configured to face the panel 50. The lower surface 244 may be seated on the panel 50 when assembled. In an exemplary embodiment, the mounting flange 240 includes a seal pocket 246 that receives a panel seal 248. The panel seal 248 is configured to be sealed to the panel 50. The panel seal 248 is sealed to the header housing 220, such as to the flange 240. The panel seal 248 forms a continuous seal surrounding the header terminals 204. The panel seal 248 may be a rubber gasket. In an exemplary embodiment, the panel seal 248 forms an airtight and/or a watertight seal between the header housing 220 and the panel 50.

The header housing 220 includes an electrical shield 250 to provide electrical shielding for the header terminals 204. The shield 250 may be connected to the plug connector 100 to electrically common the header connector 200 and the plug connector 100. Optionally, the header connector 200 may be electrically grounded to the panel 50. For example, the shield 250 may be electrically connected to the panel 50. The shield 250 may extend along the mounting flange 240 for connection to the panel 50.

In an exemplary embodiment, the header housing 220 includes one or more housing latching features 260 used to secure the mounting clip 300 to the header housing 220 (FIG. 7). In the illustrated embodiment, the housing latching features 260 are provided on the base 230. For example, the housing latching features 260 extend from the lower portion 234, such as the towers 235. In an exemplary embodiment, the housing latching features 260 include catch features 262 configured to interface with a complimentary latching feature of the mounting clip 300 to secure the header housing 220 to the mounting clip 300. The catch features 262 include catch surfaces 264, such as top surfaces of the housing latching features 260. The catch features 262 may include ramp surfaces 266 to guide the latching features of the mounting clip 300 to the catch surfaces 264. Other types of latching features may be used in alternative embodiments on the header housing 220, such as deflectable latches. The housing latching features 260 are configured to be connected to the mounting clip 300 without the use of threaded bolts. For example, the housing latching features 260 may be clipped to the mounting clip 300 with a simple pressing action. In an exemplary embodiment, the housing latching features 260 are configured to interface with the latching features of the mounting clip without the use of tools by a toolless connection in a quick and reliable manner. Other types of securing features may be used in alternative embodiments. In the illustrated embodiment, the housing latching features 260 are arranged on the outer surfaces of the towers 235 (for example, facing outward away from each other). Other locations are possible in alternative embodiments.

In an exemplary embodiment, the header housing 220 includes one or more housing pre-stage latching features 270 used to secure the mounting clip 300 to the header housing 220 (FIG. 7). In the illustrated embodiment, the housing pre-stage latching features 270 are provided on the base 230. For example, the housing pre-stage latching features 270 extend from the lower portion 234, such as the towers 235. In an exemplary embodiment, the housing pre-stage latching features 270 include deflectable latches 272 configured to interface with a complimentary latching feature of the mounting clip 300 to secure the header housing 220 to the mounting clip 300. The latches 272 include latching surfaces 274. The latches 272 may include ramp surfaces 276 to guide the latches 272 onto the latching features of the mounting clip 300. Other types of latching features may be used in alternative embodiments on the header housing 220, such as fixed latches or catch features. The housing pre-stage latching features 270 are configured to be connected to the mounting clip 300 without the use of threaded bolts. For example, the housing pre-stage latching features 270 may be clipped to the mounting clip 300 with a simple pressing action. In an exemplary embodiment, the housing pre-stage latching features 270 are configured to interface with the latching features of the mounting clip without the use of tools by a toolless connection in a quick and reliable manner. Other types of securing features may be used in alternative embodiments. In the illustrated embodiment, the housing pre-stage latching features 270 are arranged on the inner surfaces of the towers 235 (for example, facing inward toward each other). Other locations are possible in alternative embodiments.

In an exemplary embodiment, the housing latching features 260 and the housing pre-stage latching features 270 are offset from each other to allow mounting of the mounting clip 300 at different, staggered or staged positions. For example, the mounting clip 300 may be initially coupled to the housing pre-stage latching features 270 to hold the mounting clip 300 at a pre-stage position. The mounting clip may be further coupled (pressed further onto) the header housing 220 to couple to the housing latching features 260 to hold the mounting clip 300 at a final mounted position.

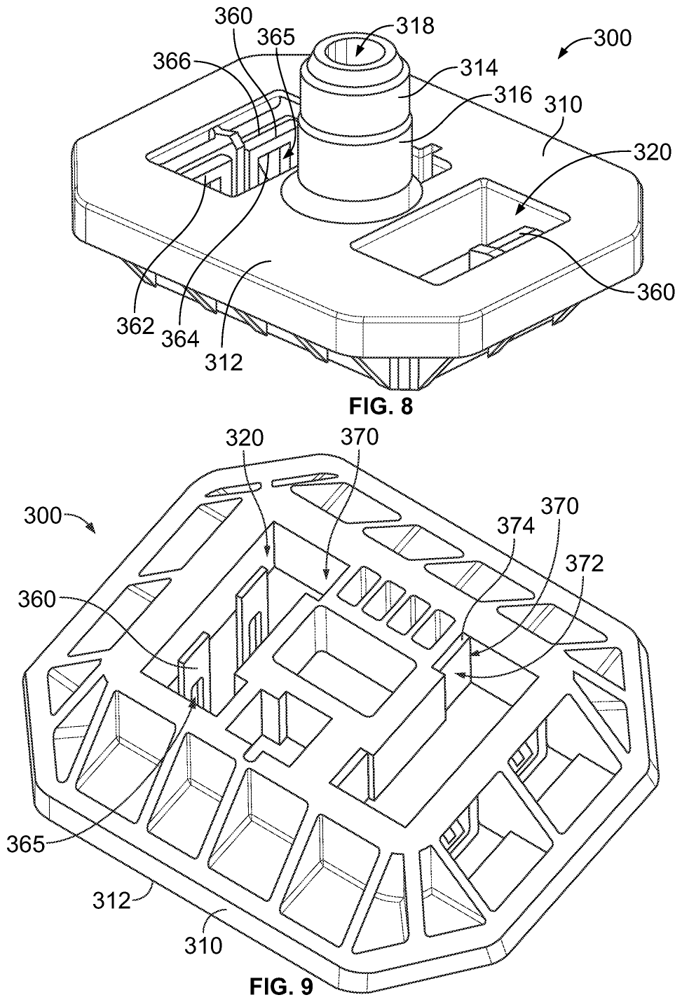

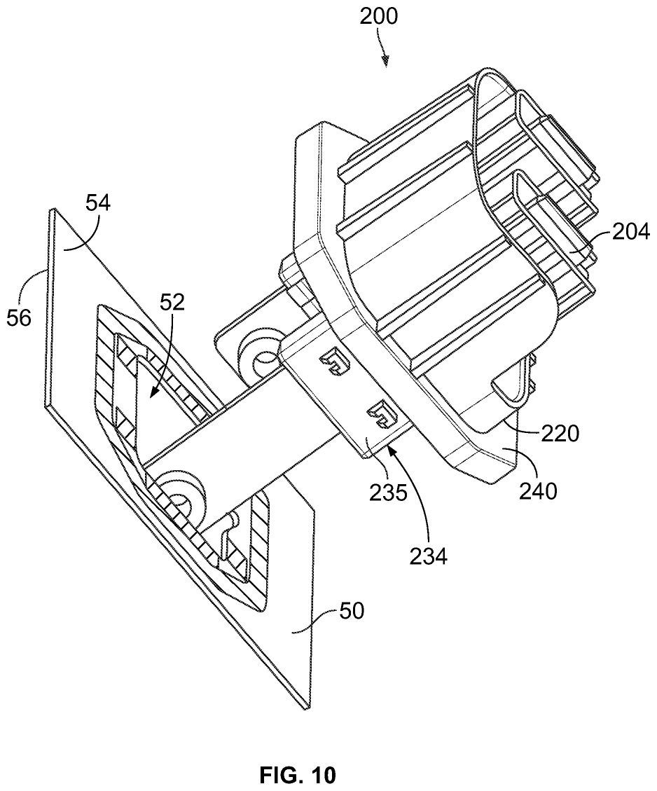

FIG. 8 is a top perspective view of the mounting clip 300 in accordance with an exemplary embodiment. FIG. 9 is a bottom perspective view of the mounting clip 300 in accordance with an exemplary embodiment.

The mounting clip 300 includes a plate 310 having a mounting surface 312. The mounting surface 312 is a top of the mounting clip 300. The mounting clip 300 may be planar. The mounting surface 312 is configured to engage a bottom surface of the panel 50. In an exemplary embodiment, the mounting clip 300 includes a plug connecting element 314 configured to interact with the plug connector 100 to secure the plug connector 100 to the mounting clip 300. In the illustrated embodiment, the plug connecting element 314 extends upward from the plate 310. The plug connecting element 314 may include a protrusion 316, such as a cylindrical post. The plug connecting element 314 may be approximately centered on the plate 310. In an exemplary embodiment, the plug connecting element 314 includes a threaded opening 318 configured to receive the threaded bolt 140. The threaded opening 318 may be a threaded insert received in the plug connecting element 314. The plug connecting element 314 may have other shapes or may be located in other locations in alternative embodiments.

The mounting clip 300 includes terminal pockets 320 that receive the header terminals 204. The pockets 320 may pass through the mounting clip 300 to allow the header terminals 204 to pass through the mounting clip 300. In an exemplary embodiment, the terminal pockets 320 receive the lower portion 234 of the base 230 of the header housing 220. For example, the terminal pockets 320 receive the towers 235. In the illustrated embodiment, the mounting clip 300 includes a pair of the terminal pockets 320. The mounting clip 300 may include greater or fewer terminal pockets 320 in alternative embodiments.

In an exemplary embodiment, the mounting clip 300 includes one or more clip latching features 360 used to secure the mounting clip 300 to the header housing 220. In the illustrated embodiment, the clip latching features 360 are provided on the plate 310. For example, the clip latching features 360 are located in the terminal pockets 320. In an exemplary embodiment, the clip latching features 360 include deflectable latches 362 configured to interface with a complimentary latching feature 262 of the header housing 220 to secure the mounting clip 300 to the header housing 220. The latches 362 include latching surfaces 364. The latching surfaces 364 may be arranged in windows 365 that receive the catching features 262. The latches 362 may include ramp surfaces 366 to guide the latches 362 onto the catching features 262 of the header housing 220. Other types of latching features may be used in alternative embodiments on the mounting clip 300, such as fixed latches or catch features. The clip latching features 360 are configured to be connected to the header housing 220 without the use of threaded bolts. For example, the clip latching features 360 may be clipped to the catching features 262 with a simple pressing action. In an exemplary embodiment, the clip latching features 360 are configured to interface with the latching features of the header housing 220 without the use of tools by a toolless connection in a quick and reliable manner. Other types of securing features may be used in alternative embodiments.

In an exemplary embodiment, the mounting clip 300 includes one or more clip pre-stage latching features 370 used to secure the mounting clip 300 to the header housing 220. In the illustrated embodiment, the clip pre-stage latching features 370 are provided on the plate 310. For example, the clip pre-stage latching features 370 may be arranged in the terminal pockets 320. In an exemplary embodiment, the clip pre-stage latching features 370 include catch features 372 configured to interface with complimentary latching features of the header housing 220, such as the deflectable latches 272 to secure the mounting clip 300 to the header housing 220. The catch features 372 include pockets or grooves or slots that define catch surfaces 374. Other types of latching features may be used in alternative embodiments on the mounting clip 300, such as deflectable latches. The clip pre-stage latching features 370 are configured to be connected to the mounting clip 300 without the use of threaded bolts. For example, the clip pre-stage latching features 370 may be clipped to the mounting clip 300 with a simple pressing action. In an exemplary embodiment, the clip pre-stage latching features 370 are configured to interface with the latches 272 without the use of tools by a toolless connection in a quick and reliable manner. Other types of securing features may be used in alternative embodiments.

In an exemplary embodiment, the clip latching features 360 and the clip pre-stage latching features 370 are offset from each other to allow mounting of the mounting clip 300 at different, staggered or staged positions. For example, the mounting clip 300 may be initially coupled to the clip pre-stage latching features 370 to hold the mounting clip 300 at a pre-stage position. The mounting clip 300 may be further coupled (pressed further onto) the header housing 220 to couple to the clip latching features 360 to hold the mounting clip 300 at a final mounted position.

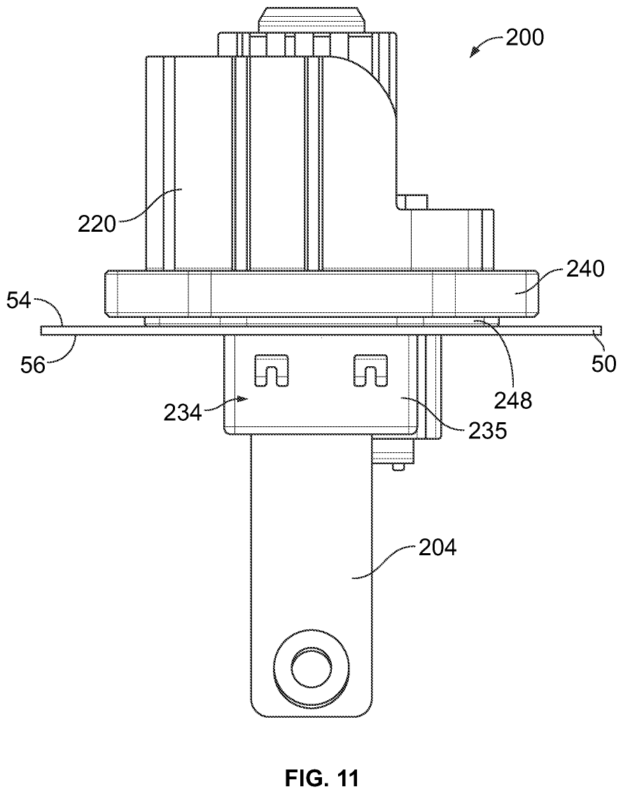

FIG. 10 is an exploded, perspective view of the header connector 200 poised for mounting to the panel 50. FIG. 11 is a side view of the header connector 200 mounted to the panel 50. During assembly, the header connector 200 is aligned with the opening 52 in the panel 50. The opening 52 passes through the panel 50 between a top 54 and a bottom 56 of the panel 50. In the illustrated embodiment, the opening 52 is generally rectangular. However, the opening 52 may have other shapes in alternative embodiments.

Components of the header connector 200 may pass through the opening 52 to electrically connect to the component behind the panel 50. During assembly, a portion of the header connector 200 is loaded into the opening 52. For example, the lower portion 234 of the header housing 220 that extends below the mounting flange 240 are loaded through the opening 52. For example, the towers 235 and the header terminals 204 may pass through the opening 52. The mounting flange 240 faces the top 54 of the panel 50. The panel seal 248, at the bottom of the mounting flange 240, faces the top 54 of the panel 50. The panel seal 248 is configured to seal against the top 54 of the panel 50.

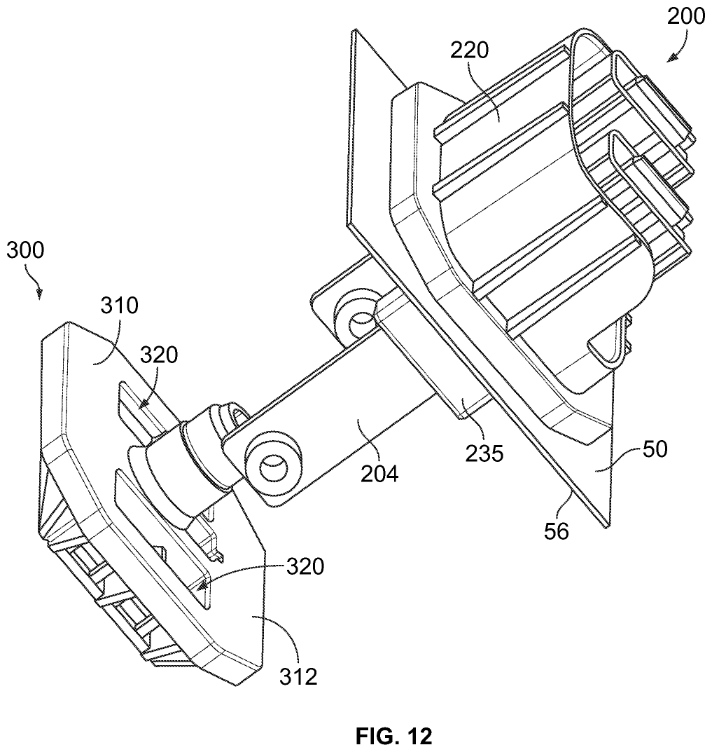

FIG. 12 is an exploded, perspective view showing the mounting clip 300 poised for mounting to the header housing 220 and the panel 50. During assembly, the mounting clip 300 is aligned with the header housing 220 below the panel 50. The terminal pockets 320 are aligned with the towers 235 and the header terminals 204. The mounting surface 312 of the plate 310 faces the bottom 56 of the panel 50. The mounting clip 300 is pressed onto the bottom of the header housing 220 to couple the mounting clip 300 to the header housing 220.

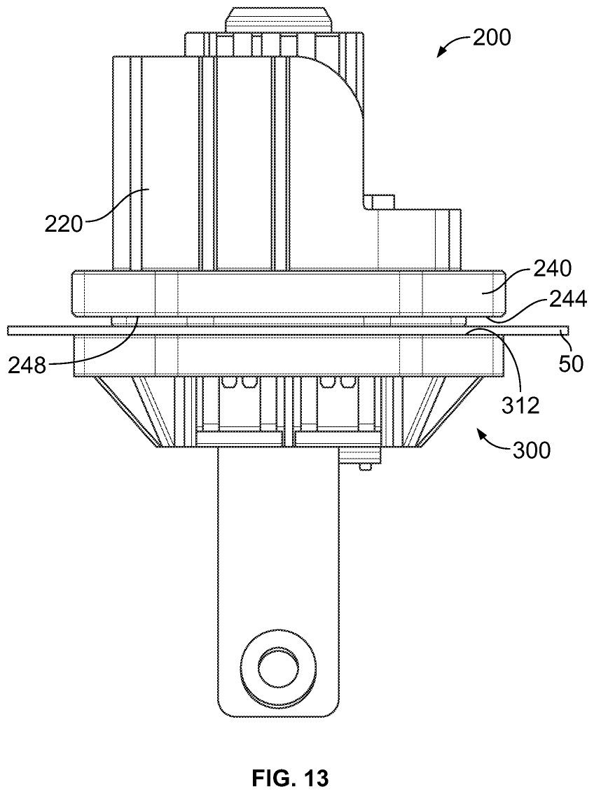

FIG. 13 is a side view of the mounting clip 300 coupled to the header connector 200 and the panel 50. FIG. 13 shows the mounting clip 300 in a pre-stage position. The mounting clip 300 is initially coupled to the header housing 220 at the pre-stage position. For example, the clip pre-stage latching features 370 are coupled to the housing pre-stage latching features 270 to hold the mounting clip 300 at the pre-stage position. The pre-stage position is different from the final mounting position. For example, the pre-stage position is less coupled, such as loosely coupled, to the header housing 220 and the panel 50. In the pre-stage position, the mounting clip 300 is secured to the header housing 220 with the panel 50 therebetween to generally position the components relative to each other prior to moving the components to the final mated position. In various embodiments, the panel seal 248 may be partially compressed in the pre-stage position.

In various embodiments, the lower surface 244 of the mounting flange 240 and/or the mounting surface 312 of the mounting clip 300 may be spaced apart from the panel 50 in the pre-stage position. There is space still provided between the lower surface 244 and the mounting surface 312 to allow further closing or pressing together on the panel 50 to the final mounting position. For example, the lower surface 244 of the mounting flange 240 and the mounting surface 312 of the mounting clip 300 are separated by a first distance, which is greater than a thickness of the panel 50 such that the lower surface 244 of the mounting flange 240 and/or the mounting surface 312 of the mounting clip 300 may be spaced apart from the panel 50. Such distance is closed or reduced when the mounting clip 300 is moved to the final mounting position.

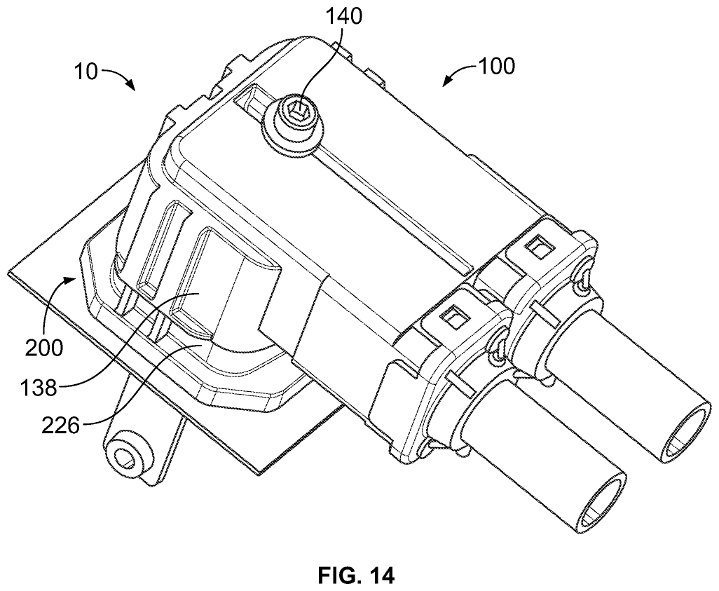

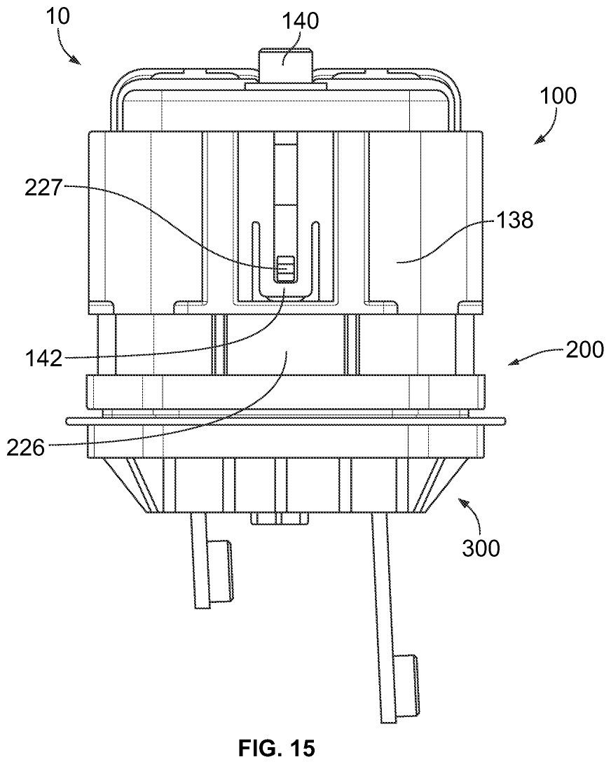

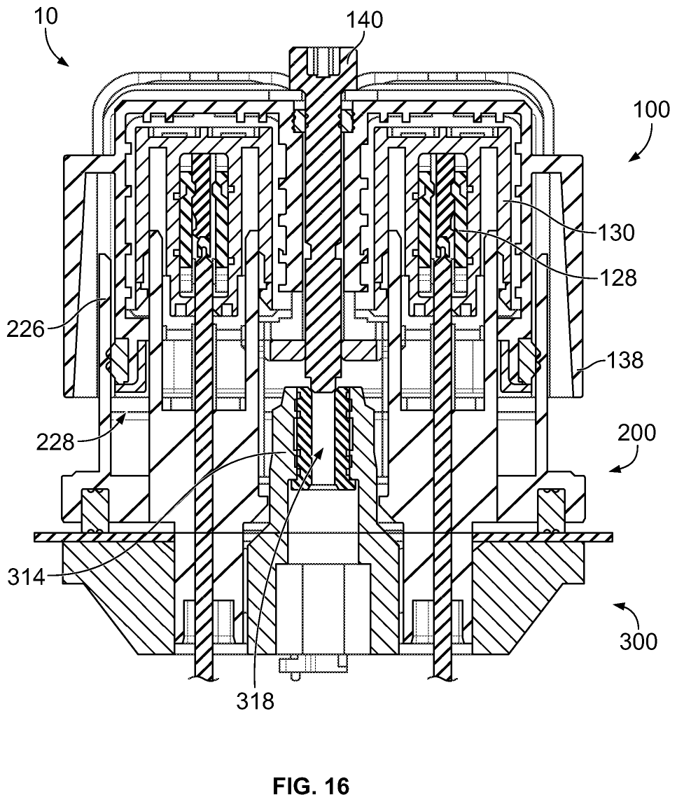

FIG. 14 is a top perspective view of the power connector system 10 showing the plug connector 100 partially coupled to the header connector 200. FIG. 15 is a side view of the power connector system 10 showing the plug connector 100 partially coupled to the header connector 200. FIG. 16 is a cross-sectional view of the power connector system 10 showing the plug connector 100 partially coupled to the header connector 200.

During assembly, the plug connector 100 is mated with the header connector 200 from above. The plug connector 100 is pressed downward onto the header connector 200. The shroud walls 226 are plugged into the plug connector 100, such as into the pocket defined by the outer wall 138. A portion of the plug connector 100, such as the terminal holder 130 and the plug terminals 128, is plugged into the chamber 228.

In an exemplary embodiment, the plug connector 100 includes an outer latch 142 along the outer wall 138 that engages a header latch 227 on the shroud wall 226. The plug connector 100 may be secured to the header connector 200 using the latches 142, 227. Optionally, the plug connector 100 is secured to the header connector 200 in a partially mated position using the latches 142, 227. In an exemplary embodiment, the threaded bolt 140 is used to secure the plug connector 100 to the header connector 200. The threaded bolt 140 is configured to be threadably coupled to the mounting clip 300, such as to the plug connecting element 314 (FIG. 16). For example, the threaded bolt 140 may be received in the threaded opening 318. The plug connector 100 may be secured to the header connector by other securing devices in alternative embodiments, such as a locking lever, a clip, or another type of locking device.

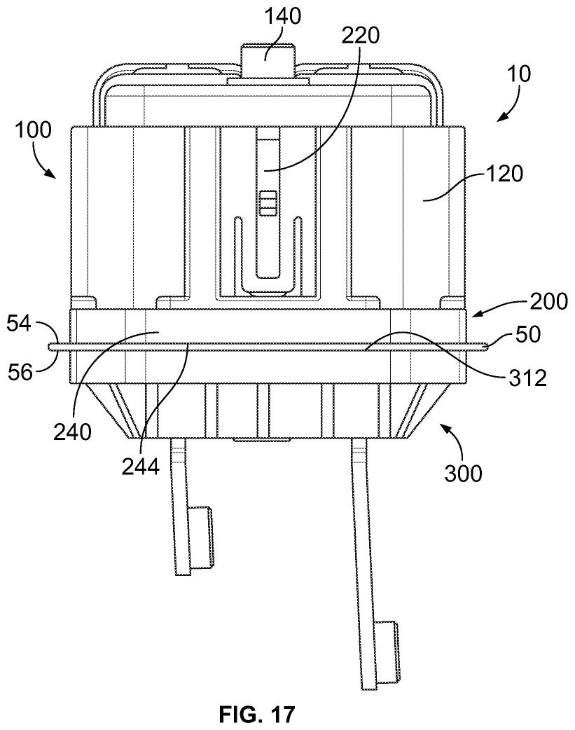

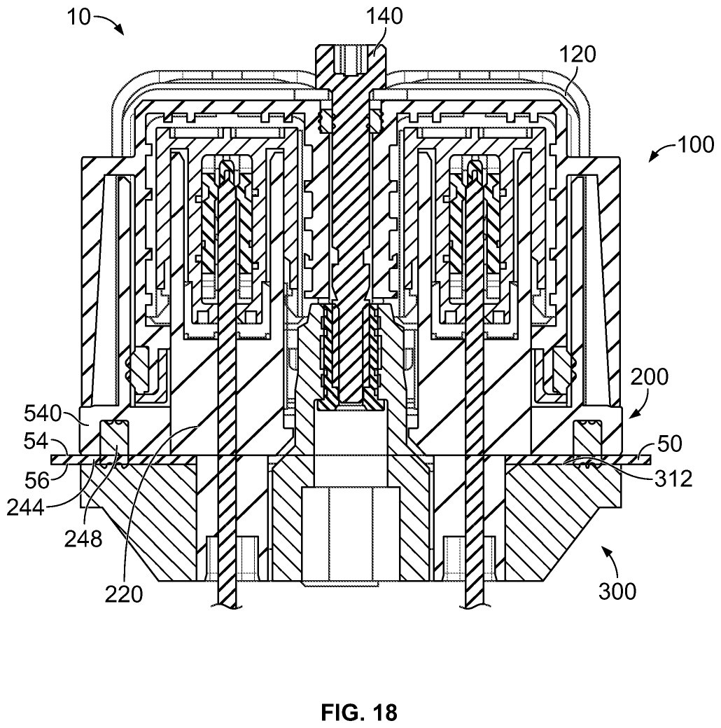

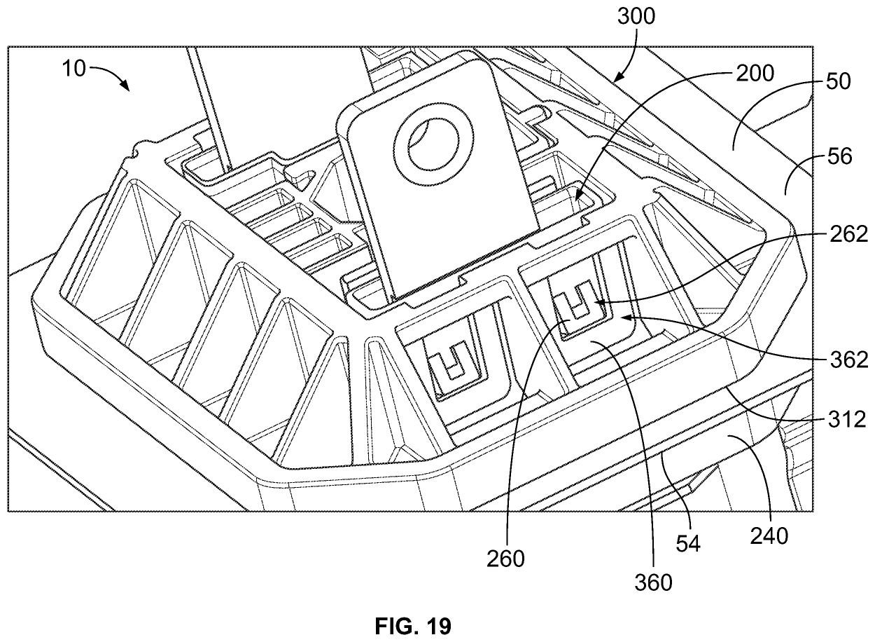

FIG. 17 is a side view of the power connector system 10 showing the plug connector 100 fully coupled to the header connector 200. FIG. 18 is a cross-sectional view of the power connector system 10 showing the plug connector 100 fully coupled to the header connector 200. FIG. 19 is a bottom perspective view of the power connector system 10 showing the plug connector 100 fully coupled to the header connector 200.

During mating, the plug connector 100 is seated on the header connector 200. For example, the plug connector 100 is forced downward on the header connector 200 to the fully mated position. The bottom of the plug connector 100 may be seated on the mounting flange 240. In an exemplary embodiment, the threaded bolt 140 is used to seat the plug connector 100 on the header connector 200. For example, the threaded bolt 140 is tightened to force the plug connector downward to the fully mated position. In alternative embodiments, other devices or tools may be used to fully mate the plug connector 100 onto the header connector 200.

In an exemplary embodiment, the threaded bolt 140 is used to fully seat the mounting clip 300 on the header housing 220. For example, as the threaded bolt 140 is tightened, the mounting clip 300 is pulled upward toward the panel 50 from the pre-stage position to the final mounting position. For example, after the plug housing 120 bottoms out against the header housing 220, further tightening of the threaded bolt 140 pulls the mounting clip 300 upward. When the mounting clip 300 is moved to the final mounting position, the clip latching features 360 are coupled to the housing latching features 260. For example, the latches 362 are latchably coupled to the catch features 262.

When the mounting clip 300 is moved to the final mounting position, the panel seal 248 is compressed and sealed between the header housing 220 and the panel 50. The panel 50 is captured between the mounting flange 240 and the mounting clip 300. For example, the lower surface 244 of the mounting flange 240 engages the top 54 of the panel 50 and the mounting surface 312 of the mounting clip 300 engages the bottom 56 of the panel 50. In the final mounted position, the lower surface 244 of the mounting flange 240 and the mounting surface 312 of the mounting clip 300 are separated by a second distance, which is equal to the thickness of the panel 50. The second distance is less than the first distance when in the pre-stage position.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A header connector comprising:
a header housing including a base having a terminal cavity, the header housing including a mounting flange extending from the base defining a mounting end configured to be mounted to a first surface of a panel, the base being received in an opening in the panel, the header housing including a shroud forming a chamber configured to receive a plug housing of a plug connector, the base including a housing latching feature;
a header terminal received in the terminal cavity and held by the base, the header terminal having a mating end configured to mate with a plug terminal of the plug connector;
a panel seal coupled to the header housing, the panel seal configured to be located between the mounting flange and the panel; and
a mounting clip having a plate configured to be mounted to a second surface of the panel, the mounting clip including a clip latching feature interacting with the housing latching feature to secure the header housing to the panel, wherein the mounting clip is secured to the base of the header housing such that the panel is captured between the plate of the mounting clip and the mounting flange of the header housing.

2. The header connector of claim 1, wherein the mounting clip forms a boltless connection to secure the header housing to the panel.

3. The header connector of claim 1, wherein the panel seal is compressed between the mounting flange and the panel when the clip latching feature interacts with the housing latching feature.

4. The header connector of claim 1, wherein the mounting clip secures the header housing to the panel when the plug connector is removed from the chamber.

5. The header connector of claim 1, wherein at least one of the housing latching feature and the clip latching feature includes a deflectable latch.

6. The header connector of claim 1, wherein the mounting clip includes a pocket receiving at least a portion of the base, the clip latching feature engaging the housing latching feature in the pocket.

7. The header connector of claim 1, wherein the mounting clip includes a clip pre-stage latching feature, the header housing including a housing pre-stage latching feature interacting with the clip pre-stage latching feature to secure the mounting clip to the header housing in a pre-stage position.

8. The header connector of claim 7, wherein the plate of the mounting clip is located a first distance from the mounting flange of the header housing in the pre-stage position, the mounting clip moving relative to the header housing from the pre-stage position to a final mounted position in which the clip latching feature interacts with the housing latching feature, the plate of the mounting clip being located a second distance from the mounting flange of the header housing in the final mounted position, the second distance being less than the first distance.

9. The header connector of claim 1, wherein the mounting clip includes a plug connecting element configured to interact with the plug connector to secure the plug connector to the mounting clip.

10. The header connector of claim 9, wherein the plug connecting element includes a threaded opening configured to be threadably coupled to a threaded bolt of the plug connector to secure the plug connector to the mounting clip.

11. The header connector of claim 1, wherein the mounting clip is configured to be loosely coupled to the header housing prior to the clip latching feature engaging the housing latching feature to loosely couple the header housing to the panel, the header housing securely fixed to the panel when the clip latching feature interacts with the header latching feature.

12. The header connector of claim 1, wherein the mounting flange does not include any openings therethrough.

13. The header connector of claim 1, wherein the base includes a lower portion configured to pass through the opening in the panel, the lower portion located below the panel, the lower portion including the housing latching feature.

14. A header connector comprising:
a header housing including a base having a terminal cavity, the header housing including a mounting flange extending from the base defining a mounting end configured to be mounted to a first surface of a panel, the base being received in an opening in the panel, the header housing including a shroud forming a chamber configured to receive a plug housing of a plug connector, the base including a housing pre-stage latching feature, the base including a housing latching feature;
a header terminal received in the terminal cavity and held by the base, the header terminal having a mating end configured to mate with a plug terminal of the plug connector;
a panel seal coupled to the header housing, the panel seal configured to be located between the mounting flange and the panel; and
a mounting clip having a plate configured to be mounted to a second surface of the panel, the mounting clip including a clip pre-stage latching feature interacting with the housing pre-stage latching feature to secure the mounting clip to the header housing at a pre-stage position, the mounting clip including a clip latching feature interacting with the housing latching feature to secure the mounting clip to the header housing at a final mounted position, wherein the panel is captured between the plate of the mounting clip and the mounting flange of the header housing when the mounting clip is latchably coupled to the header housing, wherein a distance between the plate and the mounting flange is decreased from the pre-stage position and the final mounted position.

15. The header connector of claim 14, wherein the mounting clip forms a boltless connection to secure the header housing to the panel.

16. The header connector of claim 14, wherein the panel seal is compressed between the mounting flange and the panel when the clip latching feature interacts with the housing latching feature.

17. The header connector of claim 14, wherein at least one of the housing latching feature and the clip latching feature includes a deflectable latch, and wherein at least one of the housing pre-stage latching feature and the clip pre-stage latching feature includes a deflectable latch.

18. A power connector system comprising:
a header connector including a header housing having a base having a terminal cavity, the header housing including a mounting flange extending from the base defining a mounting end configured to be mounted to a first surface of a panel, the base being received in an opening in the panel, the header housing including a shroud forming a chamber configured to receive a plug housing of a plug connector, the base including a housing latching feature, the header connector including a header terminal received in the terminal cavity and held by the base, the header connector including a panel seal coupled to the header housing and configured to be located between the mounting flange and the panel, and the header connector including a mounting clip having a plate configured to be mounted to a second surface of the panel, the mounting clip including a clip latching feature interacting with the housing latching feature to secure the header housing to the panel, wherein the mounting clip is secured to the base of the header housing such that the panel is captured between the plate of the mounting clip and the mounting flange of the header housing; and
a plug connector coupled to the header connector, the plug connector including a plug housing holding plug terminal, the plug housing received in the chamber to mate the plug terminal to the header terminal.

19. The power connector system of claim 18, wherein the plug connector includes a threaded bolt, the mounting clip includes a threaded opening receiving the threaded bolt to secure the plug connector to the mounting clip.

20. The power connector system of claim 18, wherein the mounting clip forms a boltless connection to secure the header housing to the panel.
